(19) United States
(12) Patent Application Publication
(10) Pub. No.: US 2010/0107262 A1
(43) Pub. Date: Apr. 29, 2010

(54) DIGITAL RIGHTS MANAGEMENT METHOD FOR CONTENTS BASED ON STREAMING SERVICE AND SYSTEM FOR EXECUTING THE METHOD

(75) Inventor: Woosung Lee, Seoul (KR)

Correspondence Address: H.C. PARK & ASSOCIATES, PLC, 8500 LEESBURG PIKE, SUITE 7500, VIENNA, VA, 22182, US

(73) Assignee: NHN Business Platform Corporation, Seongsam-si (KR)

(21) Appl. No.: 12/523,458

(22) PCT Filed: Nov. 13, 2007
(86) PCT No.: PCT/KR2007/005680

§ 371 Date: Jul. 16, 2009

(30) Foreign Application Priority Data
Jan. 16, 2007 (KR) 10-2007-0004670

(51) Int. Cl. G06F 21/00

(52) U.S. Cl. 726/31; 726/26

(57) ABSTRACT

A digital rights management (DRM) method for a content based on a streaming service and a system for executing the method are provided. The DRM method includes the steps of: generating and maintaining content information about a content; and updating a number of plays of the content information when play information is received from a service page displaying the content, wherein the content and a cloned identical content are classified using different identifiers.

### CROSS-REFERENCE TO RELATED APPLICATIONS

This application is the National Stage of International Application No. PCT/KR2007/005680, filed Nov. 13, 2007, and claims priority from and the benefit of Korean Patent Application No. 10-2007-0004670, filed on Jan. 16, 2007, which are both hereby incorporated by reference for all purposes as if fully set forth herein.

### BACKGROUND OF THE INVENTION

1. Field of the Invention

The present invention relates to a digital rights management (DRM) method for a content based on a streaming service and a system for executing the method. More particularly, the present invention relates to a method and system that can maintain and update content information about advertisement content that is provided using a streaming service, and thereby can identify how the content is being used and also can compute advertising effect and an advertisement charge associated with the content based on the content information.

2. Discussion of the Background

A banner advertisement in context of the Internet refers to a type of advertisements in which a content promoting goods and services is displayed in the form of a graphic image in a predetermined portion of a webpage. The banner advertisement is in the shape of a banner and puts an advertisement in a predetermined format using a moving image file, and the like, and charges fees for the advertisement. To analyze advertising effects, the number of times that the advertisement banner is displayed for users and the number of times that a graphic image of the banner advertisement is downloaded for a predetermined period of time may be calculated and sent to an advertiser.

In its initial stage, the banner advertisement was a simple form of promoting a business content in a rectangular shape. However, the banner advertisement is currently using various technologies, for example, including a video or displaying a banner on a fixed location of a screen when a webpage or homepage is being viewed.

The banner advertisement is generally charged based on cost per mill (CPM). CPM refers to a rate that is charged to the advertising service subscriber (advertiser) when Internet users are viewing a banner advertisement one thousand times. Accordingly, if CPM is 100 Korean Won, the advertisement services charges 100 Korean Won to the advertiser for the display of the advertisement content one thousand times on some Internet users' screens. Mill refers to 1,000 in roman numerals.

Unlike the banner advertisement, viral advertisement marketing or virus advertisement marketing refers to a marketing technique which enables Internet users to promote a company or products of the company by propagating certain multimedia contents (although not limited thereto) about the company or products using emails or other Internet communication channels or media. The viral advertisement marketing is named as such since the advertisement may be distributed like a computer virus. Also, the viral advertisement marketing has been highlighted as a new Internet advertisement technique since the end of the year of 2000. Since the viral advertisement may be promoted to consumers without the company's direct participation, the viral advertisement is different from existing advertisement methods.

Companies generally produce new and interesting contents to satisfy Internet users while following fashion, trends, and the like, and place the contents on Internet websites, and the like, for free. Through the above operation, the companies may include company names or products in the contents, thereby indirectly advertising the company names or the products.

When Internet users read an interesting content, they generally transmit the content to other Internet users via emails or other media. Through the repeating operation, marketing may be effectively performed. The viral advertisement marketing may be based on a web animation technology. In this instance, a file size is comparatively smaller, and the file may require the real time payment. Also, since the content may be produced in a simple way, promotion costs may be inexpensive.

FIG. 1 is a diagram illustrating an example of the viral advertisement marketing. In the viral advertisement marketing, a company corresponding to an advertisement entity or an agency executing the viral advertisement marketing displays a content 101 on an Internet site, and the like. In this instance, the content 101 may be cloned, cloned or downloaded by users accessing the content 101, and may be played in the same site or a different site.

Also, a plurality of contents 102 played in the same site or the different site may be cloned, distributed, or downloaded by other users. Through the above operation or step, the plurality of contents 102 may be distributed to a large number of users. Also, a company name or a product included in the content 101 may be transferred to the larger number of users, and promoted.

However, in the viral advertisement marketing, when the agency produces a content and executes marketing of the content, it may be difficult to identify how much the content has been distributed and promoted. Also, it is difficult to create a standard to compute a charge associated with the content, which is different from the banner advertisement.

Also, the contents may be provided using a streaming service. The streaming service plays voice, image, animation, and the like in the Internet in real time. Until now, for playing of a file, the file needs to be downloaded to a hard disk. Therefore, a user has to wait until the downloading is completed and the sufficient capacity of the hard disk must be secured. However, the streaming scheme plays flowing data in a receiving end and thus the user does not need to wait. Therefore, there is no constraint on the capacity of the hard disk.

However, in this case, it may be difficult to identify how a content about the viral advertisement marketing, particularly, a content that is provided using the streaming service is being used. Also, when the agency produces the content and marketing of the content, it may be difficult to identify how much the content has been distributed and promoted. Also, it is difficult to create a standard to compute a charge associated with the content, which is different from the banner advertisement.

### SUMMARY OF THE INVENTION

An aspect of the present invention provides a digital rights management (DRM) method for a content based on a streaming service and a system for executing the method.

Another aspect of the present invention also provides a method and system that can provide a different identifier for each cloned content of a content provided using a streaming service, and maintain and update a number of plays of the content, a number of clonings, a Universal Resource Locator (URL) of a service page displaying the content, and the like for each different identifier and thereby can obtain content information regarding how the content is being used.

Another aspect of the present invention also provides a method and system that can identify a number of plays of a content for each different identifier using content information and compute an advertisement charge for the content.

Another aspect of the present invention also provides a method and system that can distribute an advertisement charge for each service page using a number of plays and each different identifier, and compute advertising effect and an advertisement charge associated with the content for each particular site using a URL.

According to an aspect of the present invention, there is provided a digital rights management (DRM) method including the steps of: generating and maintaining content information about a content; and updating a number of plays of the content information when play information is received from a service page displaying the content, wherein the content and a cloned identical content are classified using different identifiers.

In an aspect of the present invention, the content information may include a number of plays, a number of clonings, a parent identifier, and a Universal Resource Locator (URL) of the service page for each different identifier associated with the content. Also, the step of generating and maintaining may generate and maintain a field for storing the number of plays, the number of clonings, the parent identifier, and the URL of the service page for each different identifier associated with the content.

Also, the method may further include the steps of: the cloning information is received from the service page; and transmitting the new identifier to the service page, wherein the service page responds to a cloning request for the content and displays a cloned content that includes the new identifier.

Also, the method may further include the steps of: computing an advertisement charge associated with an advertisement content using the content information, wherein the content includes the advertisement content. Also, the step of computing may include the steps of: identifying the number of plays of the content information for each different identifier; and computing the advertisement charge of the advertisement content using the number of plays, the different identifiers, and a parent identifier of each different identifier.

According to another aspect of the present invention, there is provided a DRM system for managing a content, including: a content information management module configured to generate and maintain content information about the content; an information receiver configured to receive play information from a service page displaying the content; and a play number updating module configured to update a number of plays of the content information when play information is received, wherein the content and a cloned identical content are classified using different identifiers.

### BRIEF DESCRIPTION OF THE DRAWINGS

FIG. 1 is a diagram illustrating an example of a viral advertisement marketing according to a conventional art;

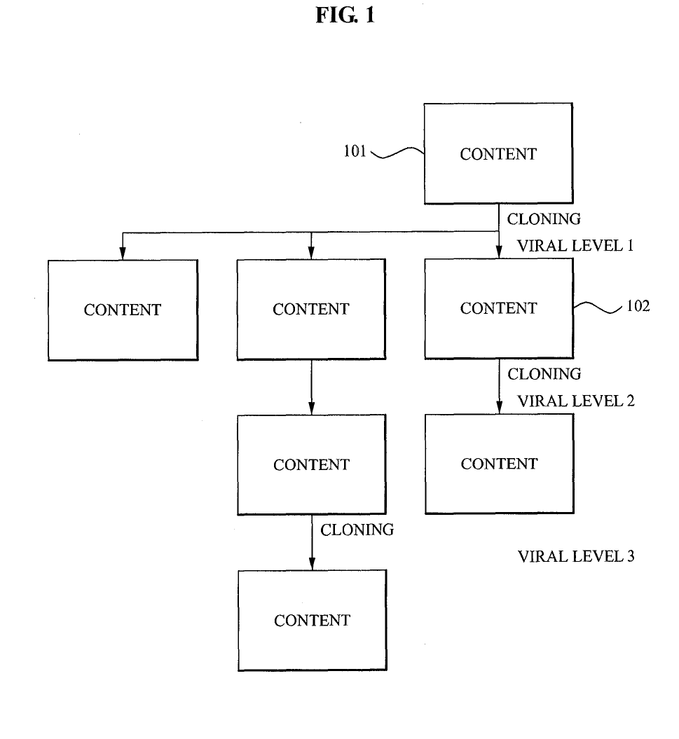

FIG. 2 illustrates a digital rights management (DRM) system according to an exemplary embodiment of the present invention;

FIG. 3 is a flowchart illustrating a DRM method according to an exemplary embodiment of the present invention;

FIG. 4 is a table illustrating an example of content information according to an exemplary embodiment of the present invention;

FIG. 5 is a flowchart illustrating a method of computing an advertisement charge for an advertisement content using content information according to an exemplary embodiment of the present invention;

FIG. 6 illustrates an example of a method of distributing a computed advertisement charge for each service page according to an exemplary embodiment of the present invention; and

FIG. 7 is a block diagram illustrating an internal configuration of a DRM system according to another exemplary embodiment of the present invention.

### DETAILED DESCRIPTION OF THE ILLUSTRATED EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures. The term “clone/cloned/cloning” used throughout the present specification denotes all acts that copy an original work and thus include acts that copy a content such as a moving picture from an original service to another service page.

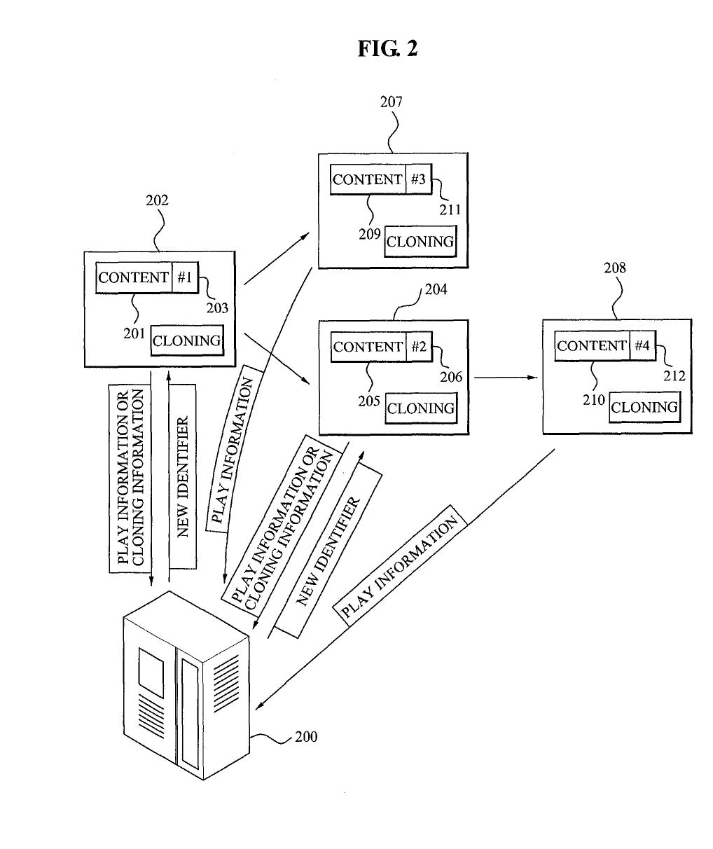

FIG. 2 illustrates a digital rights management (DRM) system 200 according to an exemplary embodiment of the present invention.

When displaying a content 201 in a service page 202, the DRM system 200 may allocate an identifier 203 corresponding to the content 201. When the content 201 is played, the service page 202 may transmit play information to the DRM system 200.

When the content 201 is cloned to another service page 204, the service page 202 may transmit cloning information to the DRM system 200. In this instance, the DRM system 200 may generate a new identifier 206 of a cloned content 205 and transmit the generated new identifier 206 to the service page 202. The service page 202 may include the new identifier 206 about the cloned content 205 of the content 201 and enables cloning to the other service page 204.

The contents 201 and 205 may be data contents that are provided using a streaming service. The identifiers 203 and 206 may be included in the data contents.

As shown in FIG. 2, the content 201 may be cloned to another service page 207. Also, the cloned content 205 of the other service page 204 may be cloned to another service page 208. As described above, the DRM system 200 may generate new identifiers 211 and 212 for contents 209 and 210 of the service pages 207 and 208, respectively. The DRM system 200 may transmit the generated new identifiers 211 and 212 to the service pages 207 and 208, respectively.

As in the service page 202, when the cloned contents 205, 209, and 210 are played in the service pages 204, 207, and 208 respectively, the service pages 204, 207, and 208 may transmit play information to the DRM system 200. The play information includes identifiers 206, 211, and 212 corresponding to the cloned contents 205, 209, and 210.

Specifically, the DRM system 200 may identify how the content 201 is being used based on the content information. Also, the DRM system 200 may compute an advertisement charge for an advertisement content that is provided based on a streaming service using the content information. The DRM system 200 may distribute the advertisement charge for each service page that displays a content based on the play information of each different service page. Also, the DRM system 200 may distribute the advertisement charge for each particular site using a Universal Resource Locator (URL) of the service page.

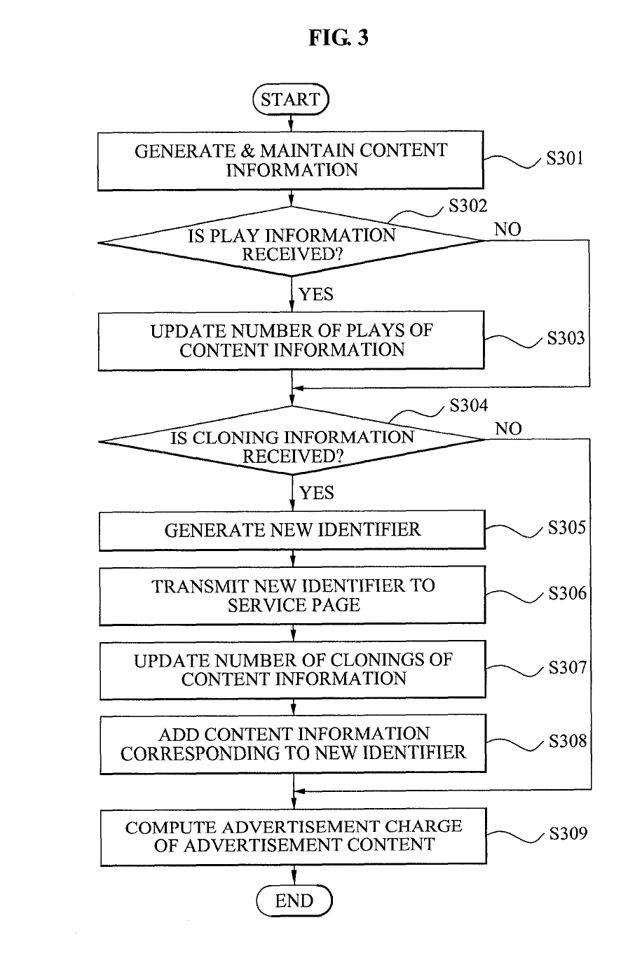

Hereinafter, the DRM method for the content will be further described in detail with reference to FIGS. 3 through 6.

FIG. 3 is a flowchart illustrating a DRM method according to an exemplary embodiment of the present invention.

In operation S301, a DRM system generates and maintains content information about a content. The DRM system computes a charge for the content. The content and a cloned identical content may be differentiated using different identifiers. The different identifier may include order information to compare generated orders.

Also, the content information may include a number of plays, a number of clonings, a parent identifier, and a URL of the service page for each different identifier associated with the content. In operation S301, the DRM system may generate and maintain a field for storing the number of plays, the number of clonings, the parent identifier, and the URL of the service page for each different identifier associated with the content.

Also, the content may be a data content that is provided using the streaming service and the identifier may be included in a script of the data content.

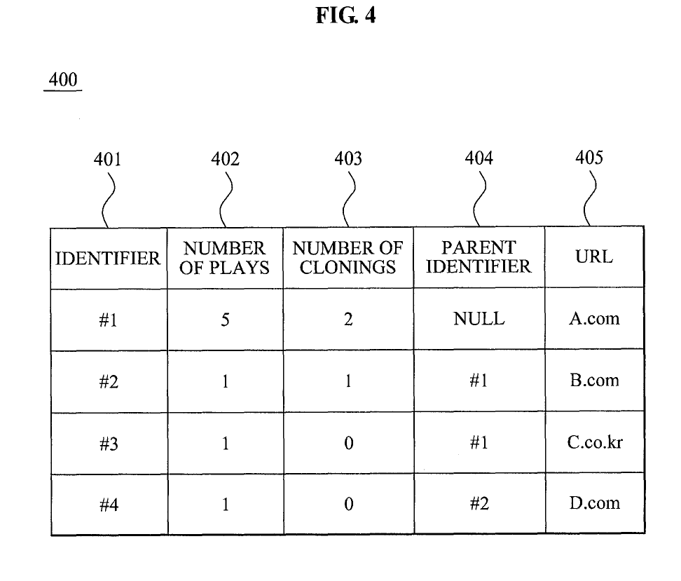

FIG. 4 is a table illustrating an example of content information 400 according to an exemplary embodiment of the present invention.

As shown in FIG. 4, the content information 400 may include an identifier 401 for identifying a content displayed in a service page, a number of plays 402 of the content that is identified by the identifier 401, a number of clonings 403 of the content, a parent identifier 404 that is an identifier of a parent content of a cloned content, and a URL 405 of the service page displaying the content.

For example, referring to data about an identifier “#4”, the number of plays 402 is “1”, the number of clonings 403 is “0”, the parent identifier 404 is “#2”, and the URL 405 is “D.com”.

Specifically, it is possible to obtain information regarding how many times the content was played in which service page based on the number of plays 402 and the URL 405. Also, it is possible to identify via which path a content that includes a random identifier was moved from an initial service page to a current service page based on the parent identifier 404 and the URL 405. For example, a content associated with the identifier “#4” was initially displayed at a URL “A.com”, and was cloned, and was displayed at a URL “B.com” and was cloned from the URL “B.com”, and is currently displayed at a URL “D.com”. The number of clonings 403 may be used as data to identify a number of users who use the service page.

In order to compute an advertisement charge for the content, the number of plays 402 may be used as data to compute a charge for the content. The number of clonings 403 and the parent identifier 404 may be used to assign a weight to the content for each identifier 401. For example, a greater weight may be assigned in a descending order of the number of clonings 403. The greater weight may be assigned in an ascending order of a distribution class that can be identified based on the parent identifier 404.

For example, the distribution class of the initially displayed content may be represented as “0”. The distribution class for cloned contents of the content may be represented as “1”, and the distribution class for another cloned contents of the cloned contents may be represented as “2”, which may be identified based on the parent identifier 404. Specifically, the parent identifier 404 with respect to the content of the identifier “#4” is “#2” and the parent identifier 404 with respect to the content of the identifier “#2” is “#1”. Therefore, the distribution class of the content of the identifier “#4” is “2”.

Also, the weight may be assigned for each URL 405 and also may be assigned for each service page displaying the content, or for each particular site. Through this, it is possible to compute advertising effect or an advertisement charge for each site.

In operation S302, the DRM system verifies whether play information is received from the service page displaying the content. When the play information is received, the DRM system performs operation S303. Conversely, when the play information is not received, the DRM system performs operation S304.

In operation S303, when the play information is received, the DRM system updates a number of plays of the content information. Specifically, when the play information is received, the DRM system may update the number of plays of the content information corresponding to an identifier of the content. Receiving of the play information indicates that the content is played in the service page that has transmitted the play information. The DRM system may perform updating by increasing the number of plays by ‘1’.

In operation S304, the DRM system verifies whether the cloning information is received from the service page. When the cloning information is received, the DRM system performs operation S305. Conversely, when the cloning information is not received, the DRM system performs operation S309.

In operation S305, when the cloning information is received, the DRM system generates a new identifier using an identifier that is included in the cloning information. As described above, the content and the cloned identical content include different identifiers, respectively. Therefore, when the content is cloned, the new identifier is required for the cloned content. For this, the DRM system may generate the new identifier using the identifier.

The identifier is used for generating the new identifier. This is because the different identifiers include order information regarding generated orders. The identifier may be a parent identifier of the new identifier. For example, when the identifier is “#2”, the new identifier may be “#3” to include order information indicating that the new identifier is generated later than the identifier. Also, when the content of the identifier “#2” is cloned again, an identifier of the secondly cloned content may be “#4” to indicate the second new identifier. The parent identifier of the new identifiers “#3” and “#4” is the identifier “#2”.

In operation S306, the DRM system transmits the new identifier to the service page. In response to a cloning request for the content, the service page may display a cloned content that includes the new identifier. As described above, the identifier may be a data content that is provided using a streaming service and the new identifier may be included in a script of the data content that is cloned according to the cloning request.

In operation S307, the DRM system may update the number of clonings of the content information corresponding to the identifier. The updating may be performed by correcting a value of a field for the number of clonings of the content information. For example, the number of clonings may be increased by ‘1’.

In operation S308, the DRM system adds information corresponding to the new identifier to the content information. The information corresponding to the new identifier may include the identifier that is the parent identifier, and a URL of another service page that transmits the cloning request for the content.

For example, when the identifier is “#2” and the new identifier is “#4”, the DRM system may generate a field for the new identifier “#4” in the content information, and add the identifier “#2” in a field for recording the parent identifier of the new identifier “#4”. Also, the DRM system may add the URL in a field for recording a URL of the new identifier “#4”. As described above, the parent identifier and the URL may be used to assign a weight for each different identifier.

Operations 5302 and 5303 are performed when the play information is received, and operations 5304 through 5308 are performed when the cloning information is received. Operations 5302 and 5303, and operations 5304 through 5308 may be reversely performed depending on which information is initially received, and also may not be performed when the play information and the cloning information are not received. Specifically, the DRM system displays a particular content and performs operations 5302 and 5303, and operations 5304 through 5308 with respect to the play information and the cloning information that is received during a predetermined period of time. When the predetermined period of time is terminated, the DRM system may compute a charge for the content using the updated content information.

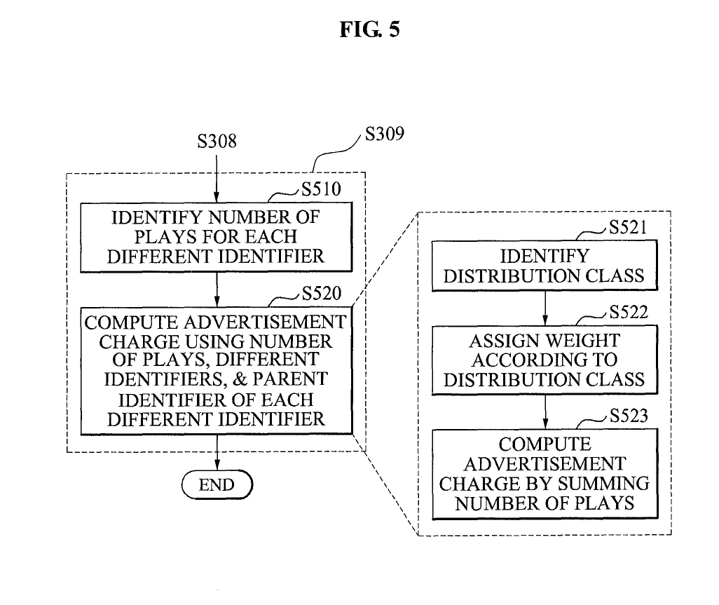

In operation 5309, the DRM system computes an advertisement charge for an advertisement content using the content information. The content may include the advertisement content. The method of computing the advertisement charge for the advertisement content will be described in detail with reference to FIG. 5.

FIG. 5 is a flowchart illustrating a method of computing an advertisement charge for an advertisement content using content information according to an exemplary embodiment of the present invention. As shown in FIG. 5, operations 5510 and 5520 may be included in operation 5309 of FIG. 3 and thereby be performed.

In operation 5510, the DRM system identifies the number of plays of the content information for each different identifier. Referring to the example of content information of FIG. 4, it is possible to identify the number of plays of the identifier “#1” as “5”, the number of plays of the identifier “#2” as “1”, the number of plays of the identifier “#3” as “1”, and the number of plays of the identifier “#4” as “1”.

In operation 5520, the DRM system computes the advertisement charge of the advertisement content using the number of plays, the different identifiers, and a parent identifier of each different identifier. Operation 5520 may include operations 5521 through 5523.

In operation 5521, the DRM system identifies a distribution class that is determined according to the parent identifier for each different identifier of the advertisement content. In the above example, it is possible to identify the distribution class of the identifier “#1” as “0”, the distribution of the identifier “#2” as “1”, the distribution class of the identifier “#3” as “1”, and the distribution class of the identifier “#4” as “2”.

In operation 5522, the DRM system assigns a weight to the number of plays according to the distribution class. The number of plays is differentiated for each different identifier. Specifically, a predetermined weight may be assigned to the number of plays of each different identifier according to the distribution class. The weight may be assigned by performing a multiply operation with respect to the number of plays. When the weight according to the distribution class is not desired, the weight may be set to “1”.

In operation S523, the DRM system computes the advertisement charge of the advertisement content by summing the number of plays. The advertisement charge may be computed by multiplying the result of summation and a cost per play.

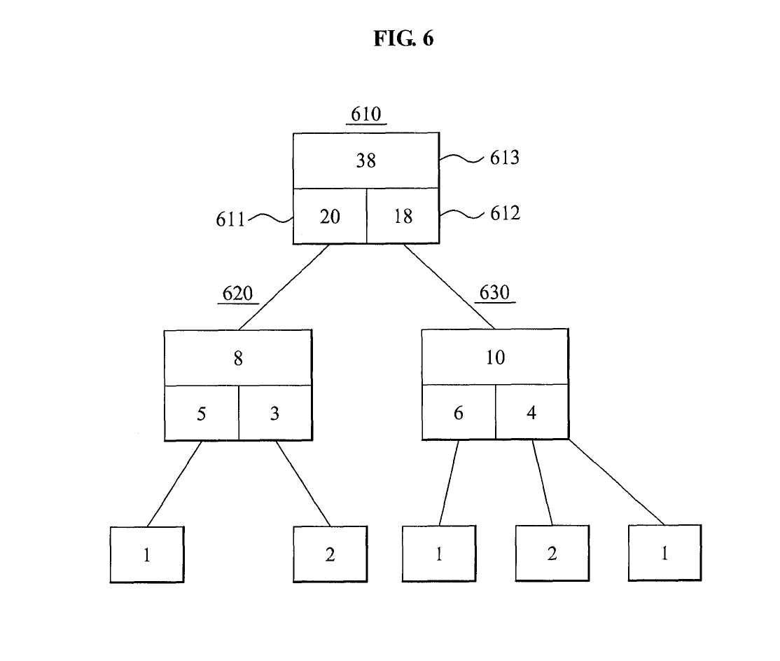

The advertisement charge of the advertisement content may be distributed based on a value that is produced from each service page. The method of distributing the advertisement charge will be further described in detail with reference to FIG. 6.

FIG. 6 illustrates an example of a method of distributing a computed advertisement charge for each service page according to an exemplary embodiment of the present invention.

A first node 610 denotes a number of plays associated with an initial content that has the distribution class of “0”. A cell 611 shows the number of plays of the initial content, and a cell 612 shows a number of plays of all identical contents that are cloned and distributed from the initial content. Also, a cell 613 shows the summation of the number of plays filled in the cell 611 and the number of plays filled in the cell 612. The cell 613 shows the total number of plays about the content associated with the first node 610.

A second node 620 and a third node 630 have the initial content as a parent content, and denote a number of plays associated with a cloned content that has the distribution class of “1”. The configuration thereof will be the same as the first node 610.

In order to assign a weight in proportion to a value that is produced by each node of FIG. 6, the weight may be generated by reflecting a first number of plays corresponding to the number of plays for each node and a second number of plays corresponding to the number of plays of a cloned node from the node. The advertisement charge may be distributed based on the weight.

For example, the first node 610 may reflect “20” which is the number of plays of the content associated with the first node 610 and “18” which is the number of plays of the cloned node of the first node 610. Specifically, the first node 610 may generate the weight by reflecting the total number of plays “38”. Also, the second node 620 may generate the weight using “8” that is the summation of “5” and “3”. The third node 630 may generate the weight using “10” that is the summation of “6” and “4”. When using the weight generation scheme reflecting the total number of plays, the first node 610 may have the weight of “ 38/63”, and the second node 620 may have the weight of “ 8/63”. “63” denotes the summation of the total number of plays with respect to each node, and may be obtained by “63=38+8+10+1+2+1+2+1”.

Specifically, the advertisement charge may be distributed for each node by assigning to the advertisement charge the weight that is computed for each node.

Also, a different weight may be assigned to each of the first number of plays that is the number of plays of each node and the second number of plays that is the number of plays of each cloned node of the node. A first weight for one node may be generated using an add operation. The advertisement charge for the node may be computed based on a ratio of a second weight of all nodes with respect to the first number of weight. For example, the weight V₁ of the first node 610 may be represented as,

Vᵢ=20×A+18×B.

When the total number of nodes is n, the advertisement charge to be distributed for the first node 610 may be given by,

$$ADVERTISEMENT CHARGE OF FIRST NODE = \frac{{V}_{1}}{{\sum }_{i = 1}^{n} Vi} \times ADVERTISEMENT CHARGE \qquad [ Equation 1 ]$$

Also, the advertisement charge may be computed for each particular site using the advertisement charge that is computed for each node, that is, for each service page displaying the content, and a URL of the service page.

As described above, when using a DRM system according to the present invention it is possible to provide a different identifier for each cloned content of a content provided using a streaming service, and maintain and update a number of plays of the content, a number of clonings, a URL of a service page displaying the content, and the like for each different identifier. Therefore, it is possible to obtain content information regarding how the content is being used.

Also, it is possible to identify a number of plays of a content for each different identifier, based on content information and compute an advertisement charge for the content. Also, it is possible to distribute an advertisement charge for each service page using a number of plays and each different identifier and compute advertising effect and an advertisement charge associated with the content for each particular site using a URL.

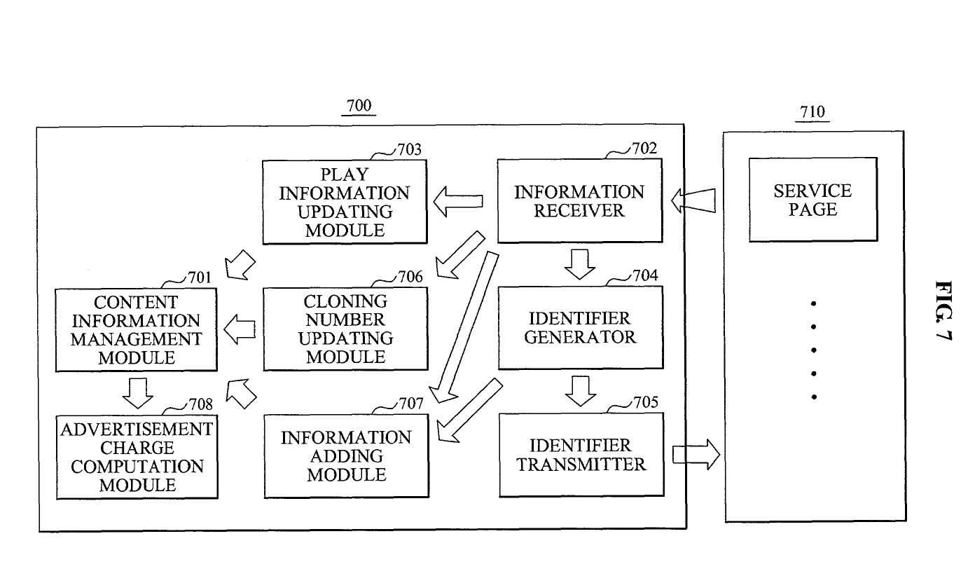

FIG. 7 is a block diagram illustrating an internal configuration of a DRM system 700 according to another exemplary embodiment of the present invention. As shown in FIG. 7, the DRM system 700 may include a content information management module 701, an information receiver 702, a play information updating module 703, an identifier generator 704, an identifier transmitter 705, a cloning number updating module 706, an information adding module 707, and an advertisement charge computation module 708.

The DRM system 700 may receive play information and cloning information about a content from a plurality of service pages 710 using the information receiver 702. The DRM system 700 may transmit a new identifier to the plurality of service pages 710 via the identifier transmitter 705.

The content information management module 701 generates and maintains content information about the content. The content and a cloned identical content may be classified using different identifiers. The content information may include a number of plays, a number of clonings, a parent identifier, and a URL of the service page 710 for each different identifier associated with the content. The content information management module 701 may generate and maintain a field for storing the number of plays, the number of clonings, the parent identifier, and the URL of each service page 710 for each different identifier associated with the content.

The information receiver 702 receives play information from the plurality of service pages 710 displaying the content. The information receiver 702 may further receive cloning information from the plurality of service pages 710. Specifically, every time the content is played or cloned, the plurality of service pages 710 may transmit the play information or the cloning information to the DRM system 700. The DRM system 700 may receive the play information or the cloning information via the information receiver 702.

When the play information is received, the play information updating module 703 updates the number of plays of the content information. Specifically, the play information updating module 703 may update the number of plays of the content information corresponding to an identifier of the content. The identifier is included in the play information received by the information receiver 702. Receiving of the play information may indicate that the content is played in the service page that transmitted the play information. The DRM system may perform updating by increasing the number of plays by ‘1’.

When the cloning information is received, the identifier generator 704 generates a new identifier using the identifier included in the cloning information. As described above, the content and the cloned identical content include different identifiers, respectively. Therefore, when the content is cloned, the new identifier is required for the cloned content. For this, the DRM system may generate the new identifier using the identifier.

The identifier is used for generating the new identifier. This is because the different identifiers include order information regarding generated orders. The identifier may be a parent identifier of the new identifier.

The identifier transmitter 705 transmits the new identifier to the service page that receives the cloning information. In response to a cloning request for the content, the plurality of service pages 710 that includes the service page may display a content that includes the new identifier. As described above, the identifier may be a data content that is provided using a streaming service and the new identifier may be included in a script of the data content that is cloned according to the cloning request.

The cloning number updating module 706 updates the number of clonings of the content information corresponding to the identifier. The updating may be performed by correcting a value of a field for the number of clonings of the content information. For example, the cloning number updating module 706 may increase the number of clonings by ‘1’.

The information adding module 707 adds information corresponding to the new identifier to the content information. The information corresponding to the new identifier may include the identifier that is the parent identifier, and a URL of another service page that transmits the cloning request for the content.

The advertisement charge computation module 708 computes an advertisement charge for the content using the content information. The content may include the advertisement content. The advertisement charge computation module 708 may include a play number identification module (not shown) and a second advertisement charge computation module (not shown). The play number identification module identifies the number of plays of the content information for each different identifier. The second advertisement charge computation module computes the advertisement charge of the advertisement content using the number of plays, the different identifiers, and a parent identifier of each different identifier.

The advertisement charge computation module 708 may identify the distribution class that is determined based on a parent identifier for each different identifier of the advertisement content, assign a weight to the number of plays that is classified for each different identifier, according to the distribution class, and add up the total number of plays, and thereby compute the advertisement charge of the advertisement content.

As described above with reference to FIG. 6, the advertisement charge may be distributed for each service page. Also, the advertisement charge may be computed for each particular site associated with the plurality of service pages, using the URL.

When using a DRM system according to the present invention, it is possible to provide a different identifier for each cloned content of a content provided using a streaming service, and maintain and update a number of plays of the content, a number of clonings, a URL of a service page displaying the content, and the like for each different identifier. Therefore, it is possible to obtain content information regarding how the content is being used.

Also, it is possible to identify a number of plays of a content for each different identifier, based on content information and compute an advertisement charge for the content. Also, it is possible to distribute an advertisement charge for each service page using a number of plays and each different identifier and compute advertising effect and an advertisement charge associated with the content for each particular site using a URL.

The exemplary embodiments of the present invention include computer-readable media including program instructions to implement various operations embodied by a computer. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

According to the present invention, there is provided a method and system that can provide a different identifier for each cloned content of a content provided using a streaming service, and maintain and update a number of plays of the content, a number of clonings, a Uniform Resource Locator (URL) of a service page displaying the content, and the like for each different identifier and thereby can obtain content information regarding how the content is being used.

Also, according to the present invention, there is provided a method and system that can identify a number of plays of a content for each different identifier using content information and compute an advertisement charge for the content.

Also, according to the present invention, there is provided a method and system that can distribute an advertisement charge for each service page using a number of plays and each different identifier, and compute advertising effect and an advertisement charge associated with the content for each particular site using a URL.

As described above, the present invention has been described based on configuration components, exemplary embodiments, and drawings. However, they are used to help general understanding of the present invention and thus the present invention is not limited thereto. Those of ordinary skill in the art may make various types of modifications and changes from the descriptions. For example, for convenience of description, as one identical content is cloned, an identifier for identifying the content is simply expressed such as “#1”, “#2”, and the like. The identifier may become more complex in order to be identified from other different contents. Also, when computing a charge for the content, the charge may be computed based on a number of clonings, instead of a number of plays. Also, the charge may be computed by assigning a more weight only to the number of plays of an initial content. Specifically, various types of equivalent modifications may be made.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A digital rights management method, comprising the steps of:
generating and maintaining content information about a content and a cloned content; and
updating a number of plays of the content information of the content and the cloned content,
wherein the content and the cloned content are classified utilizing different identifiers.

2. The digital rights management method of claim 1, wherein the content information comprises at least one of a number of plays, a number of clonings, and a parent identifier, for each different identifier associated with the content and the cloned content, and
the step of generating and maintaining generates and maintains a field comprising at least one of the number of plays, the number of clonings, and the parent identifier, for each different identifier associated with the content and the cloned content.

3. The digital rights management method of claim 1, wherein the step of updating updates the number of plays of the content information when play information is received from a service page displaying the content or the cloned content, and
the method further comprising the steps of:
generating a new identifier using an identifier included in cloning information, when the cloning information is received from the service page; and
transmitting the new identifier to the service page,
wherein the service page responds to a cloning request for the content and displays a cloned content that includes the new identifier.

4. The digital rights management method of claim 3, further comprising the steps of:
updating a number of clonings of the content information corresponding to the identifier; and
adding information corresponding to the new identifier to the content information,
wherein the information corresponding to the new identifier includes a Universal Resource Locator of another service page that requests a cloning of the content and the identifier that is the parent identifier.

5. The digital rights management method of claim 1, further comprising the step of:
computing an advertisement charge associated with an advertisement content utilizing the content information,
wherein the content and the cloned content comprise the advertisement content.

6. The digital rights management method of claim 5, wherein the step of computing comprises the steps of:
identifying the number of plays of the content information for each different identifier; and
computing the advertisement charge of the advertisement content utilizing the number of plays, the different identifiers, and a parent identifier of each different identifier.

7. The digital rights management method of claim 6, wherein the step of computing comprises the steps of:
identifying a distribution class that is determined according to the parent identifier for each different identifier of the advertisement content;
assigning a weight to the number of plays according to the distribution class wherein the number of plays is classified for each different identifier; and
computing the advertisement charge of the advertisement content by summing the number of plays.

8. The digital rights management method of claim 6, wherein the advertisement charge is distributed based on the weight that is computed based on the ratio of the number of plays of each service page to the total number of plays, and
the total number of plays comprises a first number of plays of a content that comprises a random identifier and a second number of plays of another content that is cloned from the content.

9. The digital rights management method of claim 8, wherein the step of computing further comprises the steps of:
verifying a Universal Resource Locator of the service page; and
distributing the advertisement charge for each site associated with the service page, utilizing the Universal Resource Locator and the distributed advertisement charge.

10. The digital rights management method of claim 1, wherein the different identifiers comprise order information to compare generated orders.

11. The digital rights management method of claim 1, wherein the content is a data content that is provided utilizing a streaming service, and the identifier is included in a script of the data content.

12. A computer-readable recording medium having computer readable instructions stored thereon for execution by a processor to perform a method according to claim 1.

13. A digital rights management system, comprising:
a content information management module configured to generate and maintain content information about a content and a cloned content; and
a play number updating module configured to update a number of plays of the content information of the content and the cloned content,
wherein the content and the cloned content are classified utilizing different identifiers.

14. The digital rights management system of claim 13, wherein the content information comprises at least one of a number of plays, a number of clonings, and a parent identifier, for each different identifier associated with the content and the cloned content, and
the content information management modules generates and maintain a field comprising at least one of the number of plays, the number of clonings, and the parent identifier, for each different identifier associated with the content and the cloned content.

15. The digital rights management system of claim 13, further comprising an information receiver configured to receive play information from a service page displaying the content or the cloned content,
wherein the play number updating module updates the number of plays of the content information when play information is received, and
the information receiver comprises:
configuration to receive cloning information from the service page;
an identifier generator configured to generate a new identifier utilizing an identifier included in cloning information, when the cloning information is received; and
an identifier transmitter configured to transmit the new identifier to the service page.

16. The digital rights management system of claim 15, further comprising:
a cloning number updating module configured to update a number of clonings of the content information corresponding to the identifier; and
an information adding module configured to add information corresponding to the new identifier to the content information,
wherein the information corresponding to the new identifier comprises Universal Resource Locator of another service page that requests a cloning of the content, and the identifier that is the parent identifier.

17. The digital rights management system of claim 13, further comprising:
an advertisement charge computation module configured to compute an advertisement charge associated with an advertisement content utilizing the content information,
wherein the content and the cloned content comprise the advertisement content.

18. The digital rights management system of claim 17, wherein the advertisement charge computation module further comprises:
a play number identification module configured to identify the number of plays of the content information for each different identifier; and
a second advertisement charge computation module configured to compute the advertisement charge of the advertisement content using the number of plays, the different identifiers, and a parent identifier of each different identifier.
